(19) United States
(12) Patent Application Publication
(10) Pub. No.: US 2002/0059120 A1
(43) Pub. Date: May 16, 2002

(54) Method and apparatus for creating and maintaining a virtual inventory in a distributed network

(76) Inventor: James K. Milton, Monmouth Junction, NJ (US)

Correspondence Address: THOMASON, MOSER AND PATTERSON L.L.P., 595 SHREWSBURY AVE, FIRST FLOOR, SHREWSBURY, NJ, 07702, US

(21) Appl. No.: 09/767,026

(22) Filed: Jan. 22, 2001

Related U.S. Application Data
(60) Provisional application No. 60/209,838, filed on Jun. 6, 2000.

(51) Int. Cl. G06F 17/60

(52) U.S. Cl. 705/28

(57) ABSTRACT

A method and apparatus for enabling the owner of an electronic device to access a virtual inventory of goods, e.g., media contents such as music, video games and movies.

This application claims the benefit of U.S. Provisional Application No. 60/209,838 filed on Jun. 6, 2000 which is herein incorporated by reference.

The present invention relates to an apparatus, system and concomitant method for creating, maintaining, and facilitating access to a virtual inventory of media contents via a global set of interconnected computer networks, i.e., the Internet or World Wide Web. The virtual inventory of media contents allow creators and administrators of said contents to control the distribution of virtual inventory units as they circulate through a transactional network, propagation of said transactional network facilitated by this invention, where network constituents use plug and play components and applications that communicate using a virtual inventory protocol. This invention facilitates access by the consumer owner of media contents to a repository or virtual inventory of media contents via one or more web enabled devices and at different locations without having to download, store, or carry said media contents.

### BACKGROUND OF THE DISCLOSURE

Millions of Americans are learning to use the Internet in search of information and commerce. In response, numerous businesses have established web sites to conduct business transactions, thereby extending the reach of these vendors to many more consumers. This enormous flexibility of the Internet has significantly transformed how companies conduct business.

For example, the Internet has allowed vendors to reach consumers in greater numbers without the need to build local “brick and mortar” stores. This significant advantage of the Internet allows the vendors to reduce its capital expenditure.

Although the Internet has transformed the manner in which vendors sell their goods, it has not been exploited to actually transform the goods themselves to utilize the flexibility offered by the Internet. For example, the Internet has not been exploited to provide a virtual inventory of goods purchased and owned by an individual. Since the Internet is ubiquitous, a virtual inventory of goods will allow a user to access his or her virtual inventory of goods using any web enabled devices at any locations where web access is available.

However, digital transmission of media contents has increased the concerns of owners of copyrighted contents over piracy and unauthorized copying, trading, and distribution of their goods online. Although various proposed solutions involve the use of encryption/decryption technology to securely “contain” media contents as they are distributed to, perpetually stored on, and played back from consumers' device memory, such proposals still suffer many drawbacks such as: lack of persistence in security (i.e., susceptibility to tampering and “unlocking” of secure containers), lack of portability, and lack of interoperability across devices owned by the consumers.

Therefore, a need exists in the art for an apparatus and concomitant method to provide a virtual inventory of goods, e.g., media contents, where the goods can be purchased or conveyed, registered, transferred and loaned, while stored and controlled remotely (not on consumer devices), and accessed locally, on demand, from a plurality of web enabled devices and web enabled locations via a distributed network.

### SUMMARY OF THE INVENTION

In one embodiment of the present invention, a method and apparatus is disclosed that enables the owner of an electronic device or a plurality of electronic devices (e.g., computers, PDAs, set top boxes, cell phones and the like) to access a virtual inventory of goods, e.g., media contents such as music, video and movies. The accessing electronic devices of the user are associated with a single “Device Handle” (DH), where the devices are referred to collectively as a Device Family (DF). The user employs the Device Handle to connect to the Internet, where the Device Handle is registered, e.g., with an online Device Registry Node (DRN) of an online “Media Access Provider” (MAP). Once registered, the user can use the Device Handle to purchase media contents from an online vendor, e.g., Amazon.com, that sells virtual media contents. The purchase request is then verified by a media content owner or media content administrator, e.g., music companies, clearing houses and the like, via a Virtual Content Handler (VCH). Once confirmed, a “virtual inventory unit” of the purchased media content is forwarded to the Media Access Provider specified by the user. Namely, the Media Access Provider is tasked with creating and maintaining a virtual inventory of media contents owned by each registered user based upon their Device Handle.

Thus, a user can access his or her set of virtual inventory of media contents by simply using a web-enabled device at any web-enabled location through his or her Media Access Provider. For example, a user can have his music CD streamed to a web enabled device in his car without ever having to physically carry and insert the CD into a CD player in his car. In this manner, the present invention not only transforms the way media contents are transacted, but also transforms the manner in which media contents are stored and accessed. Hence, the actual digital media content is not permanently stored on the end user's personal media playback or recording devices so as to eliminate certain potential piracy hazards generally associated with distributed digital media content.

### BRIEF DESCRIPTION OF THE DRAWINGS

The teachings of the present invention can be readily understood by considering the following detailed description in conjunction with the accompanying drawings, in which:

FIG. 1 depicts a block diagram of an overview of the architecture of the present invention for providing a virtual inventory of goods, e.g., media contents, where the goods can be purchased, registered, distributed, stored, shared and accessed using a plurality of web enabled devices over a global set of interconnected computer networks, i.e., the Internet or world wide web;

FIG. 2 depicts a block diagram of a flowchart of the method of the present invention for creating and maintaining a virtual inventory;

FIG. 3 depicts a block diagram of a flowchart of the method of the present invention for accessing a user's virtual inventory;

FIG. 4 depicts a block diagram of a data structure of a virtual inventory receipt of the present invention;

FIG. 5 depicts a block diagram of a data structure of a virtual inventory unit of the present invention;

FIG. 6 illustrates a block diagram of a data structure of a virtual inventory transfer request of the present invention; and

FIG. 7 illustrates a block diagram of a data structure of a virtual inventory transfer confirmation of the present invention.

To facilitate understanding, identical reference numerals have been used, where possible, to designate identical elements that are common to the figures.

### DETAILED DESCRIPTION

The present invention is an apparatus, system and method that is designed to provide a virtual inventory of goods, e.g., media contents, where the goods can be purchased, registered, distributed, stored, shared and accessed using a plurality of web enabled devices over a global set of interconnected computer networks, i.e., the Internet or world wide web. In one illustrative embodiment, the system is an Internet Media Access Provider providing and maintaining a virtual inventory of media contents that is accessible by a registered user using a plurality of web enabled devices.

The Internet is a global set of interconnected computer networks communicating via a protocol known as the Transmission Control Protocol and Internet Protocol (TCP/IP). The World Wide Web (WWW) is a fully distributed system for sharing information that is based upon the Internet. Information shared via the WWW is typically in the form of HyperText Markup Language (HTML) or (XML) “pages” or documents. HTML pages, which are associated with particular WWW logical addresses, are communicated between WWW-compliant systems using the so-called HyperText Transport Protocol (HTTP). HTML pages may include information structures known as “hypertext” or “hypertext links.” Hypertext, within the context of the WWW, is typically a graphic or textual portion of a page which includes an address parameter contextually related to another HTML page. By accessing a hypertext link, a user of the WWW retrieves the HTML page associated with that hypertext link.

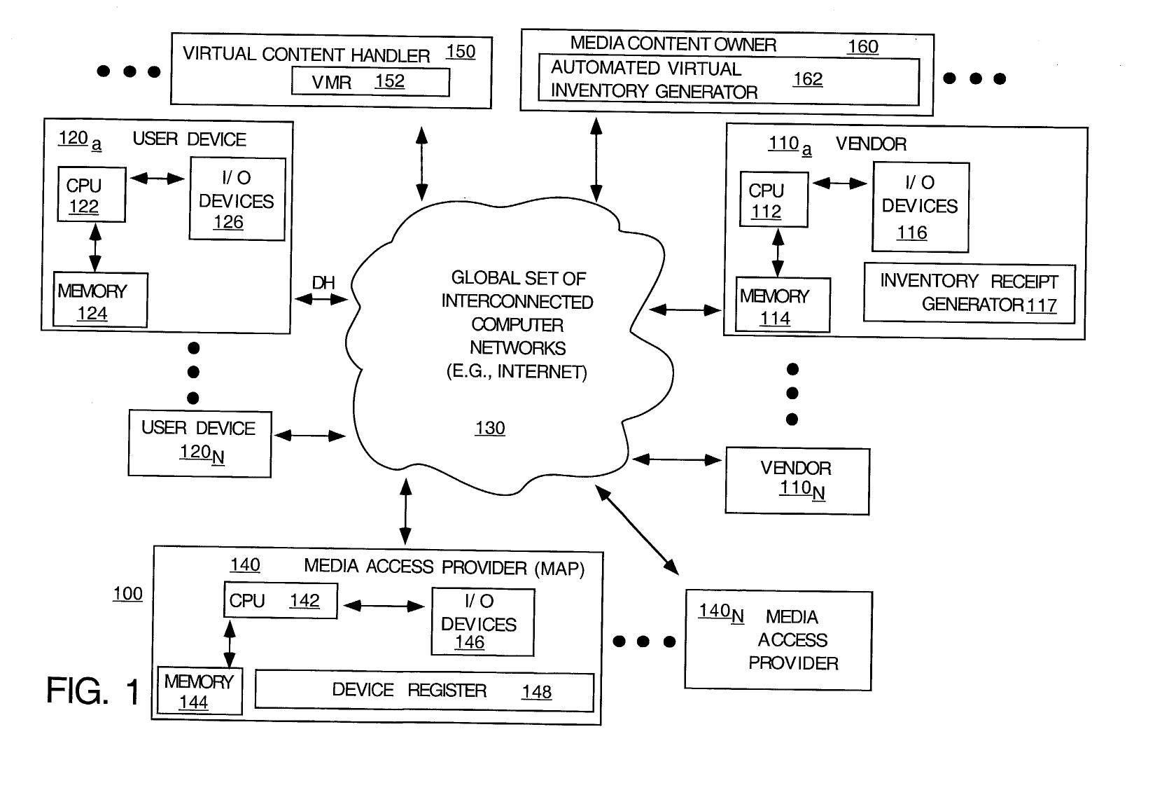

FIG. 1 depicts a block diagram of an overview of the architecture 100 of the present invention for providing a virtual inventory of goods, e.g., media contents, where the goods can be purchased, registered, distributed, stored, shared and accessed using a plurality of web enabled devices over a global set of interconnected computer networks, i.e., the Internet or World Wide Web. The architecture illustrates a plurality of user devices 120a-n, one or more media access providers 140a-n of the present invention, a plurality of vendors 110a-n, a Virtual Content Handler 150 and a Media Content Owner or Content Administrator 160 that are all connected via the Internet 130.

FIG. 1 can be broadly perceived as illustrating a Virtual Media Transactional Network (VMTN) of the present invention. In order to enable transactions between Content owners or Administrators 160, re-sellers 110, hardware makers (makers of user devices 120), consumers, and media access providers, these parties need to establish a Virtual Media Transactional Network that serves to validate and authenticate connections between each node in the distributed transaction network as facilitated by the present invention. A detailed description of the processes, protocols and data structures that can be deployed in such VMTN is provided below.

In brief, the user employs the user device 120 to connect to the Internet, where a Device Handle associated with the user device is registered, e.g., with an online Device Register 148 or Device Registry Node (DRN) of an online “Media Access Provider” (MAP) 140. Once registered, the user can use the Device Handle to purchase media contents from an online vendor 110, e.g., Amazon.com and the like, that sells virtual media contents. The purchase request is then verified by a media content owner or media content administrator 160, e.g., music companies, clearing houses and the like, via a Virtual Content Handler (VCH) 150. Once confirmed, a “virtual inventory unit” of the purchased media content is forwarded to the Media Access Provider 140 specified by the user. Namely, the Media Access Provider 140 is tasked with creating and maintaining a virtual inventory of media contents owned by each registered user based upon their Device Handle. Thus, a user can access his or her set of virtual inventory of media contents by simply using a web enabled device 120 at any web enabled location through his or her Media Access Provider 140.

More specifically, each user device 120 is an electronic device that is web enabled, i.e., having the capability to connect to the Internet and communicate via HTTP, display text, decode audio or video streams, and be programmable to store a Device ID and Device Handle. For example, the user device 120 can be a general purpose computer or Personal Digital Assistant (PDA) or other Wireless Application Protocol controlled device having a central processing unit (CPU) 122, a memory 124, and various Input/Output (I/O) devices 126. The input and output devices 126 may comprise a keyboard, a keypad, a touch screen, a mouse, a modem, a camera, a camcorder, a video monitor, any number of imaging devices or storage devices, including but not limited to, a tape drive, a floppy drive, a hard disk drive or a compact disk drive. In the present invention, various functions of the user device 120 as discussed below are implemented (in part or in whole) by a software application that is loaded from a storage device and resides in the memory 124 of the device. As such, associated methods of the user device 120 and/or data structures of the present invention can be stored on a computer readable medium.

The user device allows the user to gain access to the services and information available on the Internet. Access to such services may include, purchasing of a media content from a vendor, storing said purchased media content with a selected Media Access Provider 140 and requesting and receiving a media content stream from the Media Access Provider 140 from a remote location. The user device 120 can be adapted to block the recording of secured transmissions like those facilitated through this system, as discussed below.

The user device 120 is associated with a “Device Handle” (DH). The Device Handle is a unique code, that refers to a group of associated devices (referred to as a Device Family), and not necessarily one single device of the user in particular. The purpose of the Device Handle is to isolate and identify relationships between groups of devices of the user. The function of the Device Handle will be further described below.

The vendors 110 are simply resellers of media contents, e.g., online stores such as Amazon.com, Buy.com and the like. In one embodiment of the present invention, each of the vendors has a virtual inventory of media contents that are available for sale. Namely, each vendor does not physically stock the media contents at its warehouse, but instead, only has a list of media contents that are allocated to that particular vendor to sell to consumers. The actual physical media contents reside with the media content owner or media content administrator 160. When a user purchases a media content from the vendor, a “virtual inventory receipt” is generated by the vendor that confirms the purchase of the selected media content. This “virtual inventory receipt” is used to effect the forwarding and storing of a “virtual inventory unit” of the purchased media content with a Media Access Provider of the purchaser.

The vendor 110 associates a unique “Content Handle” for each purchased media content to the “virtual inventory receipt”. The content handle is a code, e.g., an ISRC code, that uniquely identifies a particular media content persistently. The content handle is assigned such that the unique media content that it represents and its location (i.e., based on the ownership assigned to the content handle) can be easily ascertained at any given time. For example, a list of content handles is maintained in a database of the Virtual Content Handler (VCH) 150 to allow the VCH to quickly and efficiently identify the relevant media content and its present location.

The vendor 110 is also implemented using a general purpose computer having a central processing unit (CPU) 112, a memory 114, and various Input/Output (I/O) devices 116. The input and output devices 116 may comprise a keyboard, a keypad, a mouse, a modem, a camera, a camcorder, a video monitor, any number of imaging devices or storage devices, including but not limited to, a tape drive, a floppy drive, a hard disk drive or a compact disk drive. In the present invention, various functions of the vendor 110 as discussed below are implemented (in part or in whole) by a software application that is loaded from a storage device and resides in the memory 114 of the computer. As such, the vendor 110 and associated methods and/or data structures of the present invention can be stored on a computer readable medium. Finally, it should be noted that the general purpose computer of the vendor 110 of the present invention should be broadly interpreted to include one or more personal computers, servers, main frames and the like.

The Virtual Content Handler 150 serves as a resource for identifying the location of the media content associated with the Content Handle. The Virtual Content Handler 150 can be an independent service or a service or function performed within a larger organization, e.g., the vendor 110 and/or the media access provider 140. Since the present invention is premised on a virtual inventory of media contents where the actual physical media contents reside at a remote location, e.g., within a storage system of the media content owner 160, the tracking of the ownership and locations of these media contents are very important. Additionally, ownership of media contents may change frequently.

In essence, the Virtual Content Handler 150 serves as a media contents directory. The Virtual Content Handler 150 maintains a list of authorized resellers 110, media access providers 140 and Media Content Owners or Administrators 160. Namely, the parties will identify themselves with unique registration codes. In turn, all participating Media Content Administrators 160 will utilize an automated content-handle association process for use in identifying the location of media content throughout the life of the media content and during ownership changes of the media content where such ownership changes affect the playback or usage of associated Virtual Inventory Units, and where such registration information is made accessible online to all VCHs 150.

For example, in one embodiment of the present invention, the VCH receives “Unit Activation Requests” from various MAPs 140, and processes these requests by forwarding them to the current Media Content Administrator 160 indicated by the particular Content Handle associated with the Virtual Inventory Unit(s). Thus, the VCH serves the important function of an on-line virtual media content directory assistant.

Additionally, the VCH employs a virtual media registry (VMR) 152. The VMR is tasked with the assignment of content handle to a media content. Namely, since the content handle will uniquely identify a particular media content that will be universally recognized, a registry must be established to register all media contents. Such registration may include additional information, e.g., the location of the media content and so on.

The Media Access Provider 140 of the present invention provides the important function of creating and maintaining a virtual inventory of media contents. Specifically, the user's Media Access Provider 140 hosts collections of Virtual Inventory Units on behalf of an end user or consumer so that the end user may connect to the MAP from an Internet connection in order to access his or her collection of media contents.

In operation, a user will register with a desired MAP to designate the selected MAP as an online service provider of the user for the purpose of receiving and maintaining a virtual inventory of media contents owned by the registered user. Namely, the Media Access Provider 140 serves as an online repository of the user's personal media contents.

The Media Access Provider 140 is also implemented using a general purpose computer having a central processing unit (CPU) 142, a memory 144, and various Input/Output (I/O) devices 146. The input and output devices 146 may comprise a keyboard, a keypad, a mouse, a modem, a camera, a camcorder, a video monitor, any number of imaging devices or storage devices, including but not limited to, a tape drive, a floppy drive, a hard disk drive or a compact disk drive. In the present invention, various functions of the Media Access Provider 140 as discussed below are implemented (in part or in whole) by a software application that is loaded from a storage device and resides in the memory 144 of the computer. As such, the Media Access Provider 140 and associated methods and/or data structures of the present invention can be stored on a computer readable medium. Finally, it should be noted that the general purpose computer of the Media Access Provider 140 of the present invention should be broadly interpreted to include one or more personal computers, servers, main frames and the like.

The Media Content Owner or Content Administrator 160 serves as the originator or holder of the actual media contents. For example, the Media Content Owner or Content Administrator 160 can be a music company, a movie company, a media content holding company, a clearing house and the like. Namely, the Media Content Owner or Content Administrator 160 is the entity that actual holds the copyrights to the media contents and is authorized to sell and distribute the media contents.

The interaction between the members of the Virtual Media Transactional Network of the present invention is best understood in view of the protocol, and the definitions of the “virtual inventory unit” and the “virtual inventory receipt” that are described below. The present protocol is defined as a Virtual Inventory Protocol (VIP).

It should be noted that the virtual content handler 150 and the media content owner 160 can be implemented using a general purpose computer having a central processing unit (CPU), a memory, and various Input/Output (I/O) devices (not shown). Namely, the virtual content handler 150 and the media content owner 160 can be implemented in a similar fashion as described above for the user device 120, vendor 110 and MAP 140.

Thus, the input and output devices may comprise a keyboard, a keypad, a mouse, a modem, a camera, a camcorder, a video monitor, any number of imaging devices or storage devices, including but not limited to, a tape drive, a floppy drive, a hard disk drive or a compact disk drive. In the present invention, various functions of the virtual content handler 150 and the media content owner 160 as discussed below are implemented (in part or in whole) by a software application that is loaded from a storage device and resides in the memory of the computer. As such, the virtual content handler 150 and the media content owner 160 and associated methods and/or data structures of the present invention can be stored on a computer readable medium. Finally, it should be noted that the general purpose computer of the virtual content handler 150 and the media content owner 160 of the present invention should be broadly interpreted to include one or more personal computers, servers, main frames and the like.

FIG. 5. illustrates the data structure of a virtual inventory unit of the present invention. In one embodiment of the present invention, the virtual inventory unit is an XML document 500 containing a plurality of data fields or data elements, e.g., a content handle 510, a device handle 520, a unit number 530, media content information 540, and/or user MAP information 550. These various data elements can be implemented as XML formatted text or cipher text.

First, the content handle 510 data element uniquely identifies a particular media content. Namely, the content handle is a universally recognized code that is assigned by a “virtual media registry” (VMR) to uniquely represent a particular media content, e.g., a particular CD of a artist, a particular video or movie and so on. This data element allows participating entities within the Virtual Media Transactional Network to quickly associate the virtual inventory unit with a unit of a particular media content. Additionally, the content handle serves to describe the location as to where the virtual inventory units will be sent to be handled and rerouted. For example, the content handle is read by the VCH 150 to determine the location of the media content to be accessed in the case of a “content access request”.

Second, the device handle 520 data element uniquely identifies or associates a particular device handle to the virtual inventory unit. This data element identifies a user or alternatively, a plurality of the user's devices that can be used to access the virtual inventory unit.

Third, the unit number 530 data element is a number or character string that uniquely identifies one unit of media content. One can perceive the unit number 530 as a unique serial number. The purpose of the unit number is to treat each virtual inventory unit as a unique unit of media content and to facilitate assignment of rules to the virtual inventory unit as said rules are embodied in an associated “Content Doctrine” as created and administered by the Media Content Administrator 160.

Fourth, the media content information 540 data element contains general information that the user recognizes when making his or her purchase or playback of the virtual inventory unit, e.g., where such information reveals title, track name, track number, artist name, copyright information, release date, and so on. These general information fields will be tagged in such a way so that entities within the Virtual Media Transactional Network can freely display this information to any users.

Fifth, the user MAP information 550 data element contains information pertaining to the purchasing user's MAP. For example, such user MAP may include but is not limited to the “user MAP ID” (e.g., a name or an internet address of the user's media access provider, e.g., America Online and the like), “user MAP username” (e.g., the user's sign on name, e.g., Jim@aol.com and the like).

Each Virtual Inventory Unit 500 or group of Inventory Units are to be generated, distributed, and accessed according to their associated “Content Doctrines”, where each Content Doctrine contains a Content Handle and instructions on how the Content is to be treated. The association between Virtual Inventory Unit(s) and Content Doctrine is created in a database located at a Media Content Administrator's node, with the association being between the virtual inventory unit number(s) and the Content Doctrine.

Each doctrine, embodied in a digital file, shall be titled according to its content handle. Content Doctrines are fully customizable, containing variable informational fields (e.g., authorized vendors, pricing of media content, payment methods, payment burden, inventory class) that can be created, utilized, and defined by the Content Administrator 160. First, the content doctrine can define or associate with a content handle a list of authorized vendors. For example, an artist or a media content owner may have a contract with a specific group of authorized vendors who are authorized to sell virtual inventory units of a media content.

Second, the content doctrine can define or associate with a content handle a pricing hierarchy. For example, a list of pricing for the media content can be associate with the type of transaction, e.g., wholesale, retail, promotion, and so on.

Third, the content doctrine can define or associate with a content handle a particular payment method. For example, payment methods may include but are limited to, a single one time payment for each virtual inventory unit, a subscription-based payment (e.g., monthly, quarterly, yearly), an access-based payment (e.g., payment based on the number of times the virtual inventory unit is accessed) and the like.

Fourth, the content doctrine can define or associate with a content handle a particular payment burden. Namely, this field defines which entity has the burden to make payment for owning or accessing the virtual inventory unit. For example, payment burden will often fall on the purchasing user. Alternatively, a sponsor or the artist may bear the payment burden for promotional distribution of media contents.

Fifth, the content doctrine can define or associate with a content handle a particular inventory class, where the inventory classes determine the general or standard rules for distribution, usage, and royalty concerns related to media content distributed via the Virtual Inventory Units.

For example, at the system level, general Inventory Classes can be defined, or predefine for the Media Content Administrators 160 for use by the “Automated Virtual Inventory Generator” (AVIG) 162. Specifically, the Media Content Administrators 160 has an AVIG that produces Virtual Inventory Units according to the classes and their attributes. The Media Content Administrator may also define and create new proprietary classes that are not included in a default specification of the overall system so to further automate the process of creating virtual inventory on the fly. Inventory Class rules will be stored in configuration files in a database located at the Content Administrators node. For example, Inventory Classes may include “Hollow”, “Evaluation”, “Finite”, and “Infinite”.

Specifically, the “Hollow” inventory class defines a class of virtual inventory of media contents that lacks general information such as track number, track name, and so on. It is designed to contain a special content handle which is understood by the VCH and media content owners as indicative of a voucher to be accepted by one or more media companies so that the consumer can prepay a unit of inventory and later decide which media content to activate in association with said inventory. For example, one implementation is a “virtual inventory unit gift certificate”.

The “Evaluation” inventory class defines a class of virtual inventory of media contents that will time out after a period of time as specified. One implementation is the distribution of evaluation copies of media contents for the sole purpose of being evaluated for possible purchase.

The “Finite” inventory class defines a class of virtual inventory of media contents that is classified as having a finite distribution parameter, thereby limiting the number of virtual inventory units that can be generated. For example, an artist may contract with a media content administrator for the distribution of the first 100,000 copies of a particular media content.

The “Infinite” inventory class defines a class of virtual inventory of media contents that is classified as having an infinite distribution parameter, thereby setting no limit as to the number of virtual inventory units that can be generated. For example, an artist may contract with a media content administrator for the distribution of a particular media content without limitation to the number of copies that are distributed via vendors.

After a media content administrator 160 has created a Content Doctrine for a group of virtual inventory units, vendors will issue receipts that adhere, when necessary, to the definitions or limitations as set forth in the content doctrines and their classes as described above. For example, an inventory group classified as finite will not yield inventory receipts to vendors when said inventory has been used up or is “out of stock”.

The AVIG performs several major functions for a given transaction.

First, it accepts data through its API (Application Program Interface) as linked to an SQL program which queries and returns relevant information from a Content Doctrine, where the Content Doctrine is located in a VIADMIN node's database. Second, the AVIG interacts with the VIADMIN to retrieve, insert and encrypt an available virtual inventory unit number 530 to complete the creation of a Virtual Inventory Unit.

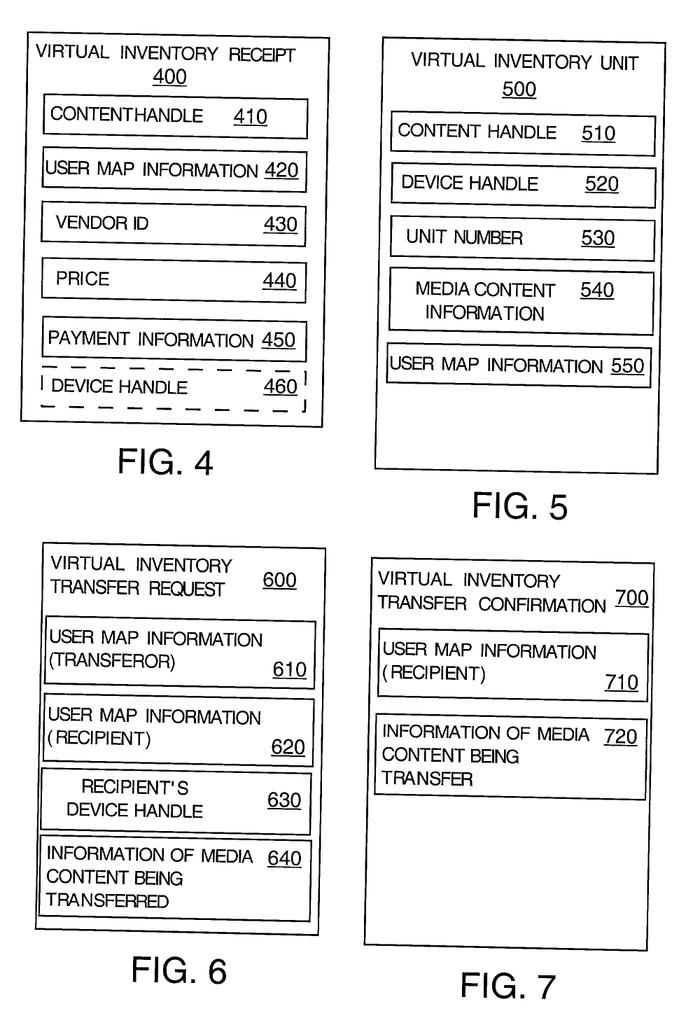

FIG. 4 illustrates a data structure of a Virtual Inventory Receipt 400 of the present invention. The Virtual Inventory Receipt 400 contains one or more of the following data fields of data elements: content handle 410, user MAP information 420, vendor ID 430, Price 440, payment information 450 and device handle 460.

Specifically, in order for vendors to initiate the process of selling media contents, the vendors must take orders or requests by consumers, and generate receipts to represent the orders or requests. In one embodiment of the present invention, an Inventory Receipt Generator (IRG) 117 within the vendor 110 is tasked with generating receipts according to information provided by the VIP and virtual content handler and according to input by the consumer at the point of sale, e.g., input regarding the users personal MAP account information.

The content handle 410, user map information 420 and device handle 460 are identical to the definitions as disclosed above with regard to the virtual inventory unit 500. The vendor ID 430 is an identification that identifies a unique vendor, the Price 440 identifies the cost for the purchase of one unit of virtual inventory unit, and the payment information 450 provides information such as method of payment and so on.

However, in one embodiment, the various data fields of the virtual inventory receipt can be populated by more than one entity. For example, data fields 410-450 can be filled in by the vendor 110 that is generating the “unfinished” virtual inventory receipt. This unfinished receipt is forwarded to a VCH 150 which, in turn, forwards the unfinished receipt to the user's MAP 140 for completing any necessary data fields, e.g., device handle 160 to produce a “finished” virtual inventory receipt. This separation of duty allows the user's personal information to be disseminated to as few entities as possible to ensure privacy of the user.

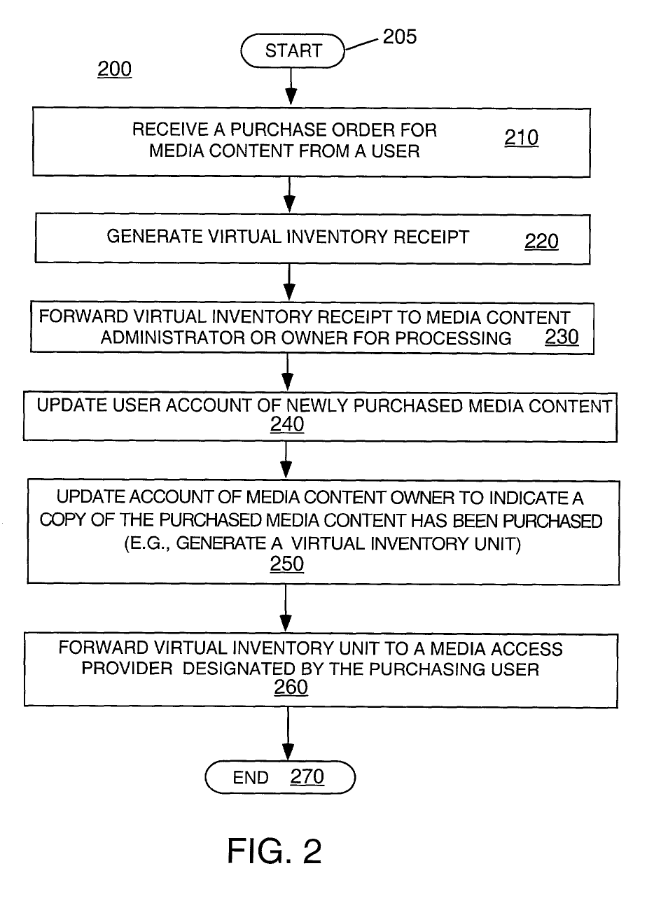

FIG. 2 depicts a block diagram of a flowchart of the method 200 of the present invention for creating and maintaining a virtual inventory. Specifically, method 220 starts in step 205 and proceeds to step 210 where method 200 receives a purchase order for media content from a user, e.g., a purchase order for the songs on a particular soundtrack of a particular artist. In one illustrative embodiment, a registered user (i.e., a user who has registered with a MAP and now has a unique device handle), has placed an order for a media content with an on-line vendor 110. In doing so, the user has provided the vendor with various information, e.g., the user's device handle, the user's MAP, and the like. Alternatively, as noted above, the user's device handle and other personal information of the user can be provided by the user's MAP when an unfinished receipt is forwarded by the VCH to MAP for completion.

In step 220, method 200 creates a virtual inventory receipt that represents the media content purchased by the user. Since no physical media content is sent to the user, the virtual inventory receipt serves as the vehicle that represents the user's purchase and, more importantly, the initialization of the process where the user's virtual inventory will be appended with the purchased media content. In operation, a unique content handler is identified on the virtual inventory receipt to identify the purchased media content. Namely, the unique content handler is universally agreed upon by various media content owners 160 to identify a particular soundtrack of a particular artist.

In step 230, method 200 forwards the virtual inventory receipt to the media content administrator or owner 160 for processing. As discussed above, in one illustrative embodiment, the virtual inventory receipt is initially forwarded to a VCH 150 and/or MAP 140 for appending additional information to complete the virtual inventory receipt. Additionally, the virtual inventory receipt is passed to a virtual content handler 150 for the purpose of identifying the location or ownership of the purchased media content. Namely, since the ownership of media contents may change frequently, the virtual content handler 150 provides the current location where the purchased media content can be obtained.

In step 240, method 200 updates the account of the user to reflect the newly purchased media content. In one illustrative embodiment, the virtual content owner 160 will contact the media access provider 140 as specified by the user during the purchase process to notify the MAP that the recently purchased media content has been approved by the virtual content owner 160.

However, the virtual content owner 160 can also notify the user's MAP that the recently purchased media content has not been approved. Namely, this will alert the purchaser that there is a problem with his or her purchase of the media content. Such problems may indicate an unauthorized vendor, an authorized vendor that has exceeded its distribution allocation, unapproved payment method, and so on.

In step 250, method 200 updates the account of the relevant media content owner that one unit of the relevant media content has been purchased. In one illustrative embodiment, the virtual content handler 150 will forward the virtual inventory receipt to the relevant media content owner 160. Using the information on the virtual inventory receipt, the media content owner 160 will generate a virtual inventory unit. It should be noted that the virtual inventory unit is not a physical copy of the purchased media content, but instead, serves as an authorization to have access to the purchased media content via the media access provider by the user.

In step 260, the virtual inventory unit is forwarded to the MAP of the user. This virtual inventory unit is added to other virtual inventory units owned by the user, thereby forming a virtual inventory of media contents. The user can now access his or her entire virtual inventory of media contents using one or more web enabled devices using the Internet. Method ends in step 270.

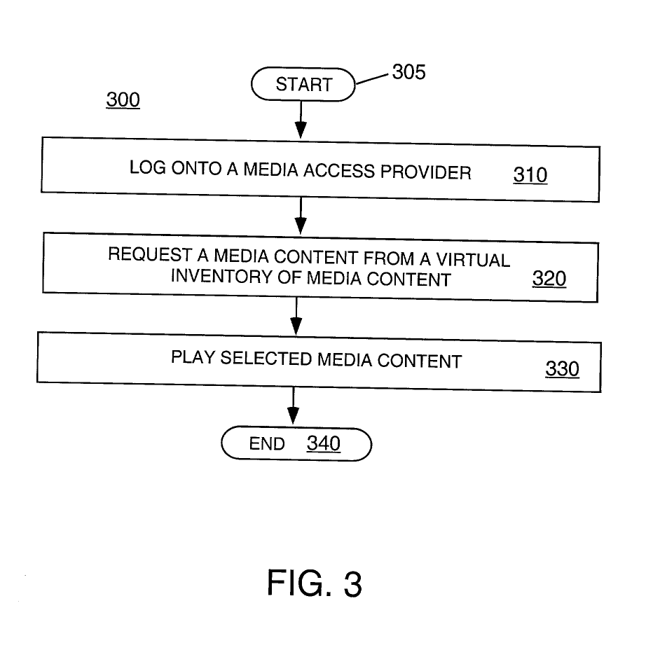

FIG. 3 depicts a block diagram of a flowchart of the method 300 of the present invention for accessing a user's virtual inventory. Specifically, method 300 starts in step 305 and proceeds to step 310 where the user logs onto his or her media access provider.

In step 320, the user selects and requests a media content from his virtual inventory. In one illustrative embodiment, the media access provider 140 forwards the content access request to the virtual content handler 150 which, in turn, forwards the request to the proper media content owner 160. Once the request is authenticated, the media content owner 160 streams the relevant media content directly to the user or via the media access provider 140 of the user. Namely, the MAP can serve as a matchmaker in establishing a connection between the media content owner and the consumer so that the consumer can stream and access content from the media content owner on to his or her device.

In step 330, method 300 plays the selected media content. In one illustrative embodiment, the media content owner 160 forwards the stream of media content to a web enabled device specified by the user either directly or via the MAP of the user. Method 300 ends in step 340.

It should be noted that the participating entities of the present virtual media transactional network can be “mirrored” all over the world. To illustrate, if a user requests to play his media content, the user's MAP will attempt to look for the nearest VCH in proximity to the user's present location. In turn, the VCH will also forward the user's access request to the closest content repository (i.e., media content owner) in proximity to the user.

The present virtual media transactional network provides an extremely flexible environment where media content can be purchased, registered, distributed, stored, shared and accessed via a distributed network from a plurality of web enabled devices and web enabled locations. For example, the sharing of media contents can now be implemented easily that will provide convenience to the consumers while protecting the rights of the media content owners.

FIGS. 6 and 7 illustrate block diagrams of data structures of a virtual inventory transfer request 600 and a virtual inventory transfer confirmation 700 of the present invention, respectively. Specifically, the virtual inventory transfer request is a data structure this is employed to effect a request for transfer of a media content from one user to another user, whereas the virtual inventory transfer confirmation is a data structure that is employed to confirm such transfer.

The virtual inventory transfer request 600 comprises the following data structures or data fields: user MAP information 610 of the transferor (e.g., MAP ID, MAP user ID and so on), user MAP information 620 of the recipient (e.g., MAP ID, MAP user ID and so on), the recipient's handle 630 and information of the media content being transferred 640 (e.g., content handle, unit number and so on). In operation, a user will request that a virtual inventory unit be transferred to another user. The MAP of the user will generate the virtual inventory transfer request 600 and will populate the relevant data fields, e.g., 610, 620 and 640. The virtual inventory transfer request 600 is then forwarded to MAP of the recipient specified by the transferor. The recipient's MAP will complete the virtual inventory transfer request 600 by populating the relevant data fields, e.g., the recipient's device handle 630. Once the virtual inventory transfer request 600 is completed, it is forwarded to the proper media content owner 160 via a VCH 150.

If the transfer is approved by the proper media content owner 160, the media content owner 160 will require that the virtual inventory unit be deleted or removed from the transferor's account. Additionally, a virtual inventory transfer confirmation 700 will be forwarded to the recipient's MAP confirming the transfer. The virtual inventory transfer confirmation 700 comprises the following data structures or data fields: user MAP information 710 of the recipient (e.g., MAP ID, MAP user ID and so on), and information of the media content being transferred 720 (e.g., content handle, unit number and so on). A new virtual inventory unit will then be forwarded to the MAP of the recipient. The virtual inventory transfer confirmation 700 allows the MAP of the recipient to accept the new inventory unit, since no virtual inventory receipt was previously generated.

Finally, it should be noted that as part of its account management function, a MAP will access and retrieve a “Device ID” from a user's device upon first and subsequent uses of the MAP service via the user's various devices. This function will allow the MAP to update the user's device handle with a family of user devices.

Although various embodiments which incorporate the teachings of the present invention have been shown and described in detail herein, those skilled in the art can readily devise many other varied embodiments that still incorporate these teachings.

What is claimed is:

1. A method for providing a virtual inventory of media contents, said method comprising the steps:
a) maintaining a user account using a device handle that uniquely identifies said user;
b) associating a plurality of media contents that are owned by said user in said user account; and
c) presenting said plurality of media contents to be accessed by said user.

2. The method of claim 1, wherein said associating step b) associates said plurality of media contents in accordance with a plurality of virtual inventory units, where each of said virtual inventory units corresponds to one of said plurality of media contents.

3. The method of claim 1, wherein said maintaining step a) maintains a device handle that is associated with one or more user web enabled devices.

4. The method of claim 1, further comprising the step of:
d) receiving a virtual inventory receipt that is representative of a media content purchased by said user.

5. The method of claim 1, further comprising the step of:
d) receiving a virtual inventory transfer confirmation that is representative of a media content that is to be transferred to said user.

6. The method of claim 1, further comprising the step of:
d) receiving a virtual inventory unit that is representative of a media content owned by said user.

7. A computer-readable medium having stored thereon a plurality of instructions, the plurality of instructions including instructions which, when executed by a processor, cause the processor to perform the steps comprising of:
a) maintaining a user account using a device handle that uniquely identifies said user;
b) associating a plurality of media contents that are owned by said user in said user account; and
c) presenting said plurality of media contents to be accessed by said user.

8. The computer-readable medium of claim 7, wherein said associating step b) associates said plurality of media contents in accordance with a plurality of virtual inventory units, where each of said virtual inventory units corresponds to one of said plurality of media contents.

9. The computer-readable medium of claim 7, wherein said maintaining step a) maintains a device handle that is associated with one or more user web enabled devices.

10. The computer-readable medium of claim 7, further comprising the step of:
d) receiving a virtual inventory receipt that is representative of a media content purchased by said user.

11. The computer-readable medium of claim 7, further comprising the step of:
d) receiving a virtual inventory transfer confirmation that is representative of a media content that is to be transferred to said user.

12. The computer-readable medium of claim 7, further comprising the step of:
d) receiving a virtual inventory unit that is representative of a media content owned by said user.

13. An apparatus for providing a virtual inventory of media contents comprising:
means for maintaining a user account using a device handle that uniquely identifies said user;
means for associating a plurality of media contents that are owned by said user in said user account; and
means for presenting said plurality of media contents to be accessed by said user.

14. The apparatus of claim 13, wherein said associating means associates said plurality of media contents in accordance with a plurality of virtual inventory units, where each of said virtual inventory units corresponds to one of said plurality of media contents.

15. The apparatus of claim 13, wherein said maintaining means maintains a device handle that is associated with one or more user web enabled devices.

16. The apparatus of claim 13, further comprising means for receiving a virtual inventory receipt that is representative of a media content purchased by said user.

17. The apparatus of claim 13, further comprising means for receiving a virtual inventory transfer confirmation that is representative of a media content that is to be transferred to said user.

18. The apparatus of claim 13, further comprising means for receiving a virtual inventory unit that is representative of a media content owned by said user.

19. A virtual media transactional network comprising:
a media content owner for providing a virtual inventory unit that represents a unit of media content;
a virtual content handler for registering a content handle to said media content;
a vendor for offering said unit of media content for sale to a user; and
a media access provider for storing said virtual inventory unit in an account of said user when said virtual inventory unit is purchased by said user.

20. A method for providing a virtual media transactional network, said method comprising the steps:
a) providing a virtual inventory unit that represents a unit of media content;
b) registering a content handle to said media content;
c) offering said unit of media content for sale to a user; and
d) storing said virtual inventory unit in an account of said user when said virtual inventory unit is purchased by said user.

21. A computer-readable medium having stored thereon a plurality of instructions, the plurality of instructions including instructions which, when executed by a processor, cause the processor to perform the steps comprising of:
a) providing a virtual inventory unit that represents a unit of media content;
b) registering a content handle to said media content;
c) offering said unit of media content for sale to a user; and
d) storing said virtual inventory unit in an account of said user when said virtual inventory unit is purchased by said user.
